(19) United States
(12) Patent Application Publication
(10) Pub. No.: US 2002/0096991 A1
(43) Pub. Date: Jul. 25, 2002

(54) Fluorescent lamp and method for manufacturing the same

(76) Inventor: Leendert Huibert Goud, Roosendaal (NL)

Correspondence Address: Corporate Patent Counsel, U.S. Philips Corporation, 580 White Plains Road, Tarrytown, NY, 10591, US

(21) Appl. No.: 10/046,627

(22) Filed: Jan. 14, 2002

(30) Foreign Application Priority Data
Jan. 15, 2001 (EP) 01200127.7

(51) Int. Cl. H01J 1/62

(52) U.S. Cl. 313/493

(57) ABSTRACT

The invention describes a fluorescent lamp comprising four or a larger, even number of glass tubes (3, 6) connected by respective bridge parts (5, 9, 10) to form a discharge path through the tubes, said lamp is constructed from two or more dual shaped lamp parts (1, 2) each comprising two substantially straight tubes (3) parallel to each other, each tube comprising a sealed end (4), and a first bridge part (5) near the sealed ends to join the tubes, wherein the bridge part (5) of one dual shaped lamp part (1) is located at a distance d1 from the sealed ends (4) of the tubes (3), whereas the bridge part (9) of the other dual shaped lamp part(s) (2) is located at a distance d2 from the sealed ends (7) of the tubes (6), said distance d2 is shorter than the distance d1 such that only a cold spot (8) is formed in a tube end part of one of the dual shaped lamp parts (1).

The present invention relates to a fluorescent lamp comprising four or a larger, even number of glass tubes according the preamble of claim 1. The invention further relates to a method for manufacturing such a fluorescent lamp.

A method for manufacturing a fluorescent lamp with eight tubes is described in UK Patent Application GB 2 335 538. The lamp is assembled from four dual tubes that are previously manufactured. Dual tubes are manufactured from two parallel glass tubes each having one end sealed. The tubes are connected to each other by means of a bridge near the sealed tube ends. The distance created between de bridge and the sealed tube ends is of such a dimension that a cold spot is created in both tube end parts. These cold spots are intended for mercury vapor pressure control and, as mercury vapor pressure determines the lamp lumen output, the effectiveness of the lamp. In the finished lamp the number of cold spots equals the number of tubes, e.g. in the lamp according to GB 2 335 538 there are eight cold spots. The creation of more cold spots than one being needed for mercury vapor pressure control is at the expense of light-emitting tube area, resulting in a lower luminous flux or longer lamp length.

The object of the invention is to provide an improved fluorescent lamp for which above-mentioned drawback does not arise.

This object is achieved in accordance with the invention with a fluorescent lamp defined in the introduction which is characterized in that the first bridge part of the first dual shaped lamp part is located at a distance d1 from the sealed ends of the tubes, and that the second bridge part of the second dual shaped lamp part is located at a distance d2 from the sealed ends of the tubes, wherein the distance d2 is shorter than the distance d1 such that only a cold spot is formed in a tube end part of the first dual shaped lamp part. Only one dual shaped lamp part has a cold spot, while the or each other dual shaped lamp part fully utilizes its length for the gas discharge, light-emitting area, which will result in a higher lumen output or reduced total lamp length.

The invention also relates to a method for manufacturing a fluorescent lamp as defined in claim 2.

The invention will now be described with reference to the accompanying drawings, in which

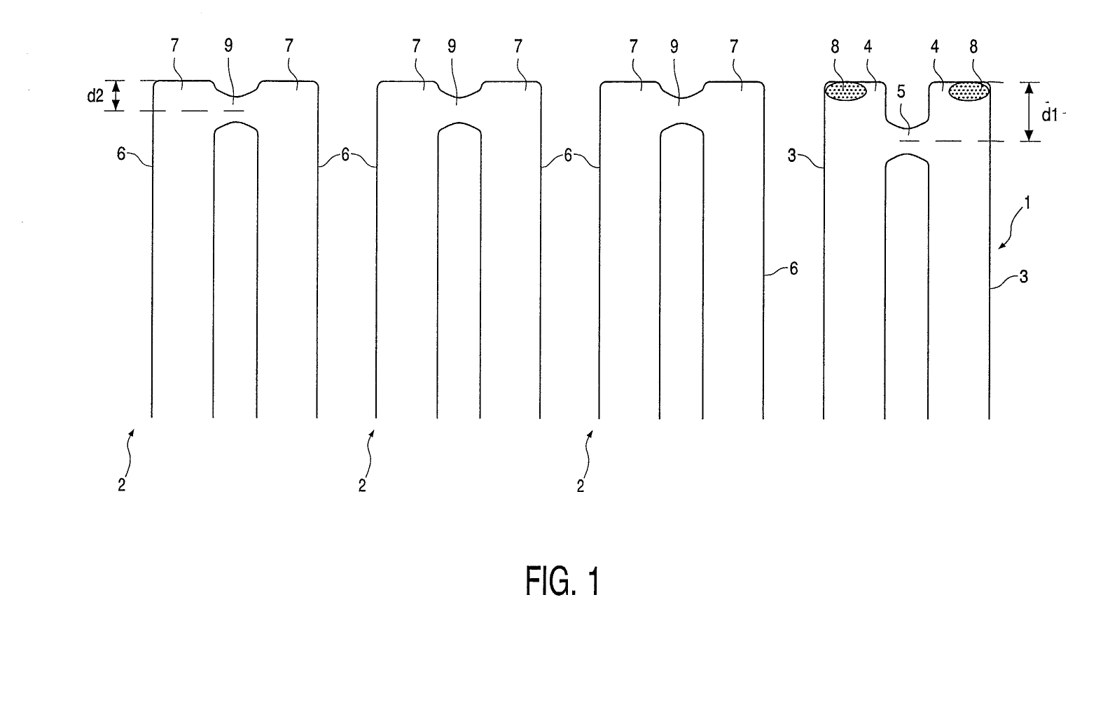

FIG. 1 illustrates schematically four dual shaped lamp parts for an eight tube lamp according to one embodiment of the invention;

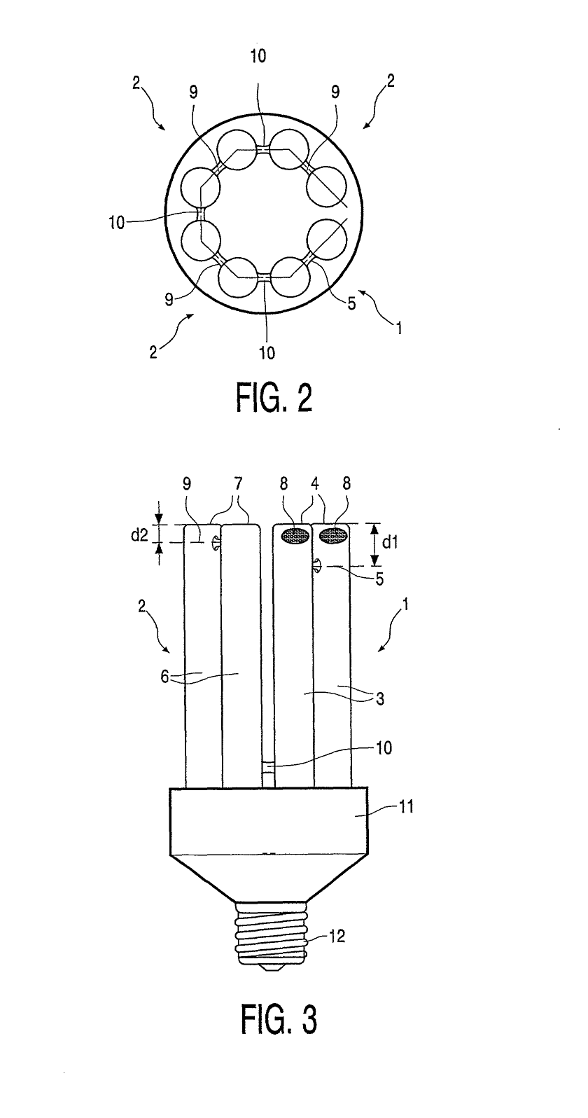

FIGS. 2 and 3 respectively are a top and front view of the eight tube lamp, and

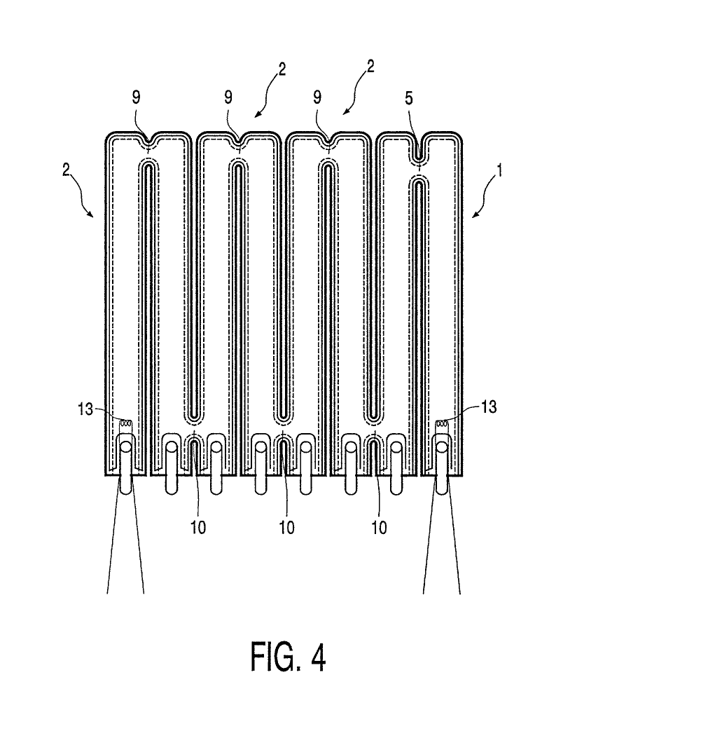

FIG. 4 is a sectional view according to line IV-IV in FIG. 2.

FIG. 1 shows schematically one first dual shaped lamp part 1 and three second dual shaped lamp parts 2 for an eight tube lamp. The first dual shaped lamp part 1 has two substantially straight tubes 3, which are parallel to each other. Each tube has one sealed end 4. Near the sealed ends 4, the tubes 3 are joined by means of a first bridge part 5. The first bridge part 5 is located at a distance d1 from the sealed ends 4 of the tubes 3. The second dual shaped lamp parts 2 each have two tubes 6, which are parallel to each other and have sealed ends 7 at one side. The tubes 6 are connected mutually by second bridge parts 9, located at distance d2 from the sealed ends 7. The distance d2 is shorter than the distance d1 such that only a cold spot 8 is formed in a tube end part of the first dual shaped lamp part 1.

In FIGS. 2 and 3 respectively a top and front view of a eight tube lamp manufactured from the dual shaped lamp parts 1, 2. In manufacturing the lamp from dual shaped lamp parts 1, 2, these are mutually connected by bridge parts 10 at the end of the tubes 3, 6 opposite to the sealed ends 4, 7 thereof. The assembly of tubes 3, 6 are finally placed in a lamp base 11 provided with screw thread 12.

Finally, FIG. 4 shows a sectional view according to line IV-IV in FIG. 2. The cold spots 8 are located in the first dual shaped lamp part 1 at the right of FIG. 4. Because the tubes 3, 6 are mutually connected by bridge parts 5, 9, 10 a discharge path is formed through the tubes 5, 9, 10 between two electrodes 13, which are provided in one tube each. As only the first dual shaped lamp part 1 has cold spots 8, the tubes 6 of the three other dual shaped lamp parts 2 use their full length for the gas discharge, light-emitting area, which results in a higher lumen output compared to an eight tube lamp known from the prior art which has eight cold spots, one in each tube.

1. Fluorescent lamp comprising four or a larger, even number of glass tubes (3, 6) connected by respective bridge parts (5, 9, 10) to form a discharge path through the tubes between two electrodes (13) each provided in one of the tubes, the lamp comprises:
a first dual shaped lamp part (1) which comprises two substantially straight tubes (3) parallel to each other, each tube comprising a sealed end (4), and a first bridge part (5) near the sealed ends to join the tubes,
at least one second dual shaped lamp part (2) which comprises two substantially straight tubes (6) parallel to each other, each tube comprising a sealed end (7), and a second bridge part (9) near the sealed ends to join the tubes, and
bridge parts (10) for mutually connecting the dual shaped lamp parts (1, 2) near the ends of the tubes (3, 6) opposite to the sealed ends (4, 7) thereof, characterized in that the first bridge part (5) of the first dual shaped lamp part (1) is located at a distance d1 from the sealed ends (4) of the tubes (3), and that the second bridge part (9) of the second dual shaped lamp part (2) is located at a distance d2 from the sealed ends (7) of the tubes (6), wherein the distance d2 is shorter than the distance d1 such that only a cold spot (8) is formed in a tube end part of the first dual shaped lamp part (1).

2. Method for manufacturing a fluorescent lamp comprising four or a larger, even number of glass tubes (3, 6) being connected by respective bridge parts (5, 9, 10) to form a discharge path through the tubes between two electrodes (13) each provided in one of the tubes, the method comprising the steps of:
a) manufacturing one first dual shaped lamp part (1) comprising of disposing two substantially straight tubes (3) parallel to each other, each tube being sealed at one end (4), and joining the tubes near the sealed ends with a first bridge part (5),
b) manufacturing at least one second dual shaped lamp part (2) comprising of disposing two substantially straight tubes (6) parallel to each other, each tube being sealed at one end (7), and joining the tubes near the sealed ends with a second bridge part (9), and
c) mutually connecting the dual shaped lamp parts (1, 2) by bridge parts (10) near the ends of the tubes (3, 6) opposite to the sealed ends (4, 7) thereof, characterized in that during step a) the first bridge part (5) is being applied at a distance d1 from the sealed ends (4) of the tubes, and that during step b) the second bridge part (9) is being applied at a distance d2 from the sealed ends (7) of the tubes, said distance d2 being shorter than d1 in such a way that only a cold spot (8) is being formed in a tube end part of the first dual shaped lamp part (1).
